(19) United States
(12) Patent Application Publication
(10) Pub. No.: US 2012/0197855 A1
(43) Pub. Date: Aug. 2, 2012

(54) Method and Apparatus of Generating Internet Navigation Page

(75) Inventor: Hua Chen, Hangzhou (CN)

(73) Assignee: ALIBABA GROUP HOLDING LIMITED, Grand Cayman (unknown)

(21) Appl. No.: 12/863,402

(22) PCT Filed: Apr. 28, 2010
(86) PCT No.: PCT/US10/32762

§ 371 Date: Jul. 16, 2010

(30) Foreign Application Priority Data
Oct. 19, 2009 (CN) 200910204196.5

(51) Int. Cl. G06F 17/00; G06F 17/30

(52) U.S. Cl. 707/706; 715/205; 715/207; 707/E17.108

(57) ABSTRACT

The present disclosure introduces a method and apparatus of generating Internet navigation page. A method of Internet navigation includes: creating a base page; receiving the user-defined website information; adding at least a web link logo on the base page based on the user-defined website information. The user-defined website information includes: website address, customized website name, and the location of the added web link logo on the base page. With the disclosed techniques, a user can personally customize the content of the navigation website based on the individual's Internet habits. On the other hand, every website link logo can be put at an arbitrary location of the navigation page. Compared to the Favorites, the navigation page has better visibility and thus more easily distinguishes websites.

### CROSS REFERENCE TO RELATED PATENT APPLICATIONS

This application is a national stage application of an international patent application PCT/US10/32762, filed Apr. 28, 2010, which claims priority from Chinese Patent Application No. 200910204196.5 filed Oct. 19, 2009, entitled “A METHOD AND APPARATUS OF GENERATING INTERNET NAVIGATION PAGE,” which applications are hereby incorporated in their entirety by reference.

### TECHNICAL FIELD

The present disclosure generally relates to computer application and, more particularly, to generating an Internet navigation page.

### BACKGROUND

With the rapid development of the Internet, the number of websites continuously increases, and the content becomes richer. Hence, a user needs to be able to conveniently and quickly find a desired website. In order to provide for the user's needs, there came to be a class of specialized websites called “navigation websites”. These websites in and of themselves do not have much content, but they collect many uniform resource locators (URLs) of popular websites and those corresponding URLs are provided to the user in link format. The navigation websites can also classify the gathered websites according to certain conditions, in order for the user to quickly find his/her desired site. Therefore, users do not need to remember every website's respective URL. Through the navigation websites, one can connect directly to the desired website.

The navigation websites often show only the usual and popular URLs. This usually satisfies the greater majority of users' needs. However, actual online habits are diverse, and the navigation websites have no means to cater to everyone's needs. Speaking from a specific user's perspective, the user may perceive that the information provided by the website is not enough. It is also possible the user may feel that there is a lot of superfluous data. Therefore, the navigation websites characteristically cannot satisfy everyone's needs.

In order to satisfy personalized Internet needs, many browsers offer features like “Favorites” and “Bookmark,” which can store URLs in link form. It is a convenient way for the user to quickly find the website, similar to the basic role of the navigation websites. In contrast with the navigation websites, the user needs to manually collect each URL and store them. Correspondingly, the user can also arbitrarily add or remove URLs according to one's own habits. However, Favorites acting as a feature of the browser in and of itself has very limited display and classification features. When there are many URLs, the user usually cannot search for the needed website in Favorites as fast as the navigation website. Further, every time a new URL is added to Favorites, it needs to be done manually, which may be cumbersome for the user.

### SUMMARY

In order to solve the aforementioned technical problem, embodiments of the present disclosure provide a method and system of generating an Internet navigation page. The user can customize the Internet navigation page according to the person's online habits.

The exemplary implementations of the present disclosure provide a technical scheme which, compared to the conventional navigation website, determines automatically the content of the navigation page according to the user's personal habits. Additionally, every web link logo can be positioned arbitrarily on the navigation page. Compared to Favorites, the navigation page has more visible features and can more easily classify the websites.

### DESCRIPTION OF DRAWINGS

It should be understood that the following figures only constitute some exemplary embodiments of the present disclosure. From the perspective of an ordinary person skilled in the art, without indulging in creating something new, one can also develop other figures based on these figures.

FIG. 1 shows a flowchart of a method of generating an Internet navigation page in accordance with the present disclosure.

FIG. 2 shows a schematic diagram of an Internet navigation page generated in accordance with the present disclosure.

FIG. 3 shows another schematic diagram of an Internet navigation page generated in accordance with the present disclosure.

FIG. 4 shows yet another schematic diagram of an Internet navigation page generated in accordance with the present disclosure.

FIG. 5 shows a flowchart of a method of generating an Internet navigation page in accordance with the present disclosure.

FIG. 6 shows a schematic diagram of a generating system of an Internet navigation page in accordance with the present disclosure.

FIG. 7 shows another schematic diagram of a generating system of an Internet navigation page in accordance with the present disclosure.

### DETAILED DESCRIPTION

In order to allow a person ordinarily skilled in the art to understand the technical schemes of the present disclosure in a better way, the technical schemes in the exemplary embodiments of the present disclosure are described in a clear and complete manner below through the accompanying figures. It should be understood that the exemplary embodiments described herein only constitute parts, not all, of the embodiments of the present disclosure. Exemplary implementations obtained by persons ordinarily skilled in the art that have not worked under the premise of the creative work, shall be considered to fall under the scope of the present disclosure.

### First Exemplary Embodiment

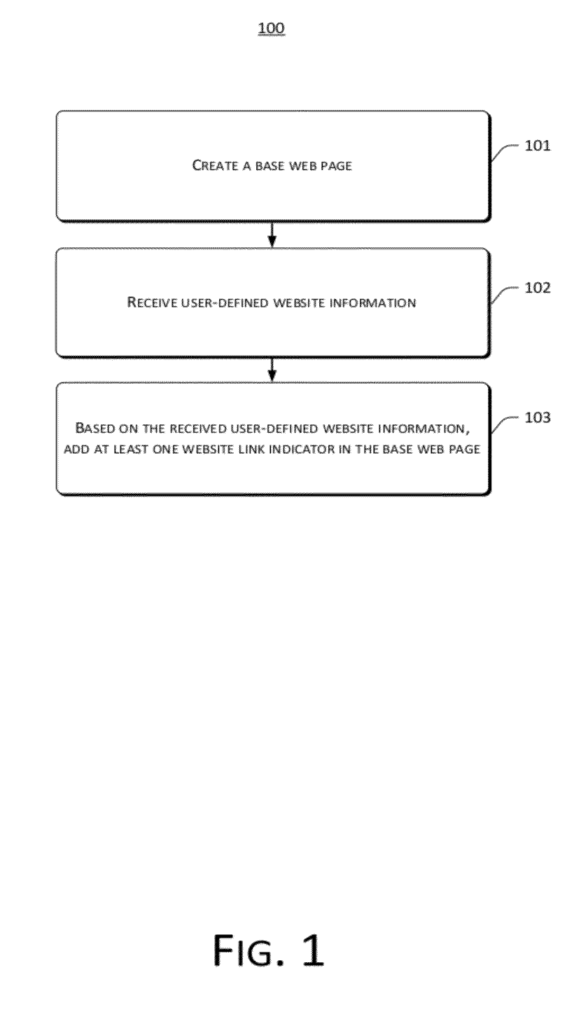

FIG. 1 illustrates a method 100 of generating an Internet navigation page in accordance with the present disclosure.

At S101, a base page is set up.

At S102, user-defined website information is received.

At S103, at least one website link logo is added on the base page, based on the received user-defined information.

The aforementioned user-defined website information needs to include a website address and a corresponding user-defined website name.

The website address (simply referred to as web address in the succeeding text) is the only information used directly to mark a website. The web address can be in the form of an Internet Protocol (IP) address, and can also be in the domain name's format. Based on the web address, browsers can directly link to the corresponding website of this address.

Every arbitrary web address corresponds to a website name (or title). Based on the web address, the system can directly obtain the corresponding website name. When adding a website link logo, the user can directly choose the default website name, and the user can also give this website a customized name. This customized name will be the website link logo's name displayed on the navigation's page.

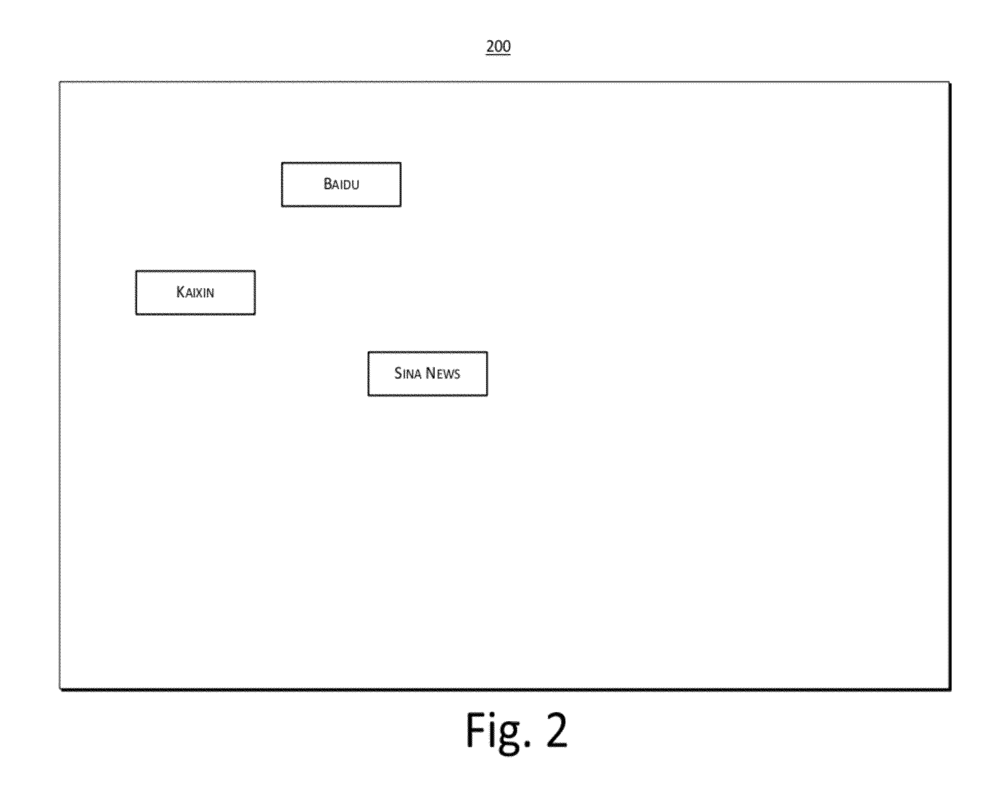

In addition, the user-defined website information, in accordance with the exemplary exposure of the present disclosure, also includes an important piece of information—the web link logo's location on the base page. The biggest difference in using the generated navigation page under the present disclosure's scheme and using the Favorites feature is that each website link logo is in one navigation page, each web link logo on the page having a unique location as shown in FIG. 2. Thus, when adding a web link logo on the page, one also needs to provide information regarding the link's location.

In general, a way to identify location information is by using the left corner's vertex of the navigation page as the origin, with pixels as units, and making an orthogonal coordinate system. This allows any point to be represented by horizontal and vertical coordinates on the navigation page. When adding the web link logo, the user can directly provide the specific coordinates. This way, the added website link logo can be presented on the corresponding location on the navigation page.

An optimization scheme for providing location information will now be described. A user first uses a mouse, keyboard, or other input devices to move a cursor on the navigation page to the desired location. Then, the user clicks on the mouse (or input device) to add the web link logo's feature. By this time, the system can automatically obtain the coordinates of the cursor's current location. The system will use the coordinates as the location information of the added web link logo. Alternatively or additionally, after obtaining the coordinates of the current cursor location, the system will display the obtained location information to the user. The user can then edit the coordinates. After confirmation by the user, the system will utilize the user-modified coordinates as the location information to add the web link logo on the navigation page.

Another optimization scheme for providing location information will now be described. The system does not ask the user to provide location information when adding a web link logo, but automatically assigns a location for the newly added web link logo based on the current page's usage status. After adding the web link logo, the logo location is revised based on the user's current location.

On the generated navigation page, the user can arbitrarily add or delete web link logos on the page. One can also modify an existing web link logo on the page. In order to modify the contents corresponding to the aspects of customized website information, a basic process is described herein. The user, in light of the existing web link logo on the current page, provides a newer website address, a customized website name, and/or location of this web link logo on the aforementioned base page. The system, based on the user-provided information, generates a corresponding web link logo.

Uniquely, to modify the location information, the user can use the mouse drag and drop method for the website link logo on the page. When the system detects the user dragging the website link logo, it will get the user's current coordinates on the navigation page in real-time and the newer real-time website link logo's location information. Using this method, the user can place each web link logo anywhere on the page based on the user's individual habits. Based on the difference of the placement of each web link, one can also categorize each website link logo, making it faster to search online for the needed website.

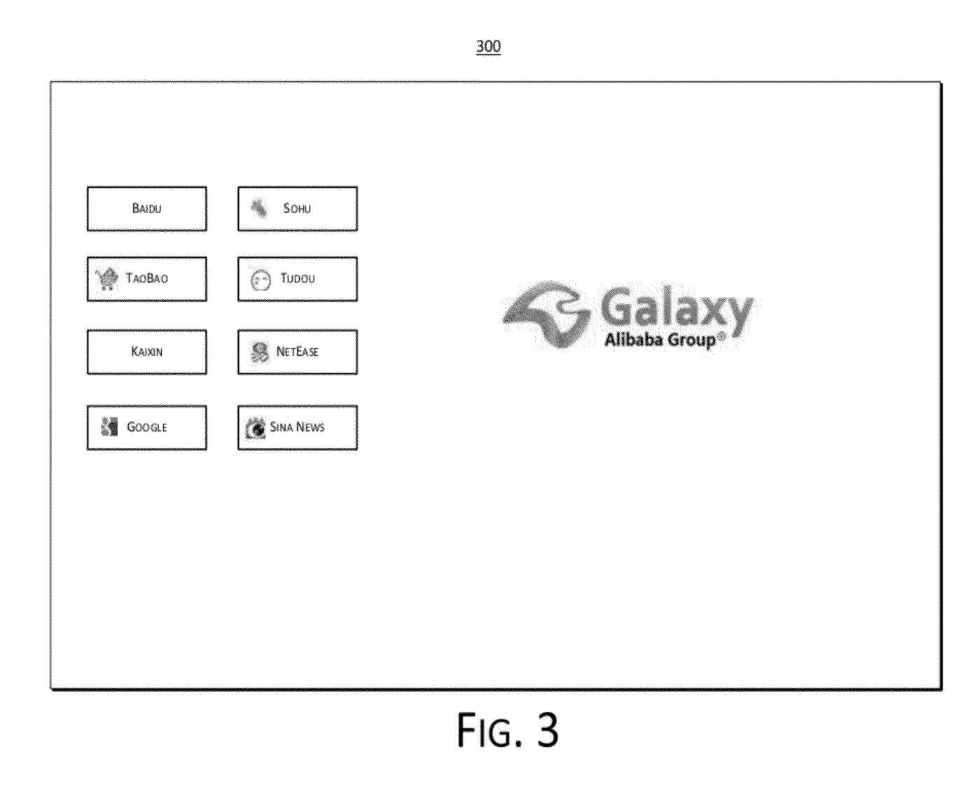

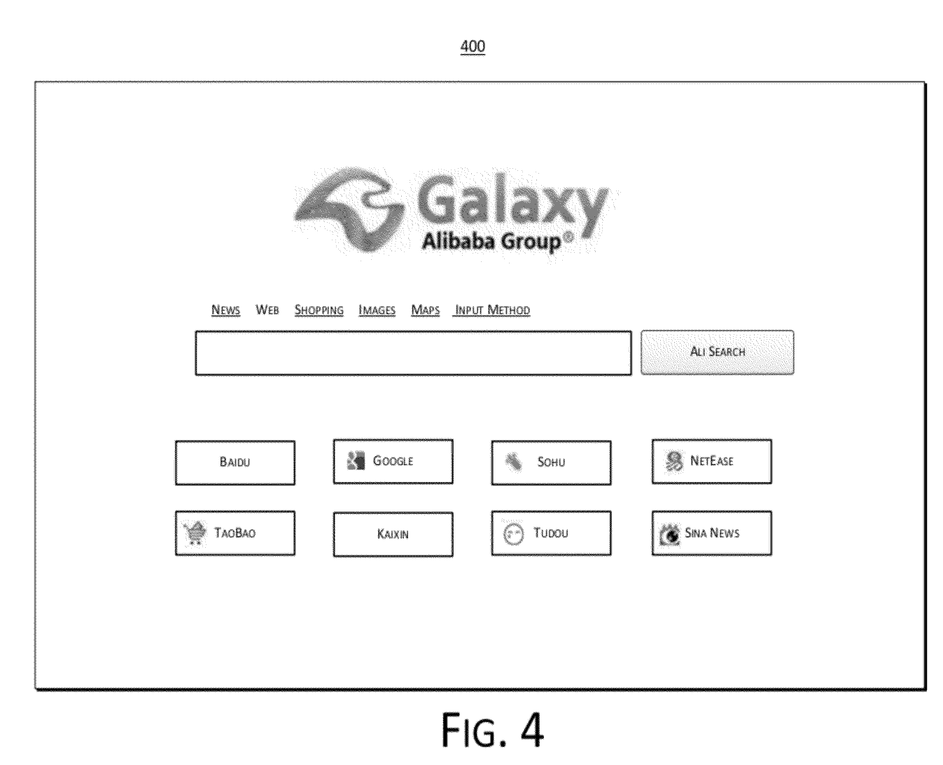

Compared to search websites or Favorites, the generated navigation page of the exemplary embodiment is more customizable and provides a better user experience. For example, it can set up an icon for each web link logo, so that each web link logo can easily be distinguished. The system can also provide a plurality of default icons from which the user can choose. The user can also utilize personalized icons. In many cases, a user is more sensitive to graphics than text. After an individualized icon for each website link logo has been set up on the page, it will be faster for the user to find the corresponding website logo. Similarly, the generated navigation page can also set up a background image of the base page via a default background image or via a user-customized background image. FIG. 3 illustrates an example of the navigation page's web link logo icons as well as the background image. A person skilled in this art can also add search engines, weather forecasts, stock quotes and other modules in order to include additional features (as shown in FIG. 4, showing the added search engine module scenario). The navigation page 300 of FIG. 3 and the navigation page 400 of FIG. 4 also fall under the present disclosure's scope.

The generated navigation page, in accordance with an exemplary implementation of the present disclosure, can be directly stored in a local computer, and can be directly set up as the home page of the browser. Compared to navigation websites, with the generated navigation page and aside from its customization feature, users need not be connected to a network when visiting the navigation page of a local computer. It can save network bandwidth that would be used to visit the navigation website. Of course, in order to avoid losing data in the local computer, one can also store the generated navigation page on the network's backup server. The exemplary implementation of the present disclosure is not limited to these cases.

### Second Exemplary Embodiment

With the existing technology, a user needs to voluntarily utilize manual methods to add web addresses to Favorites. The exemplary implementation provides a method to generate a navigation page, which can automatically ask the user to recommend one or more website, thereby eliminating the need for manual addition of a website link logo onto the navigation page.

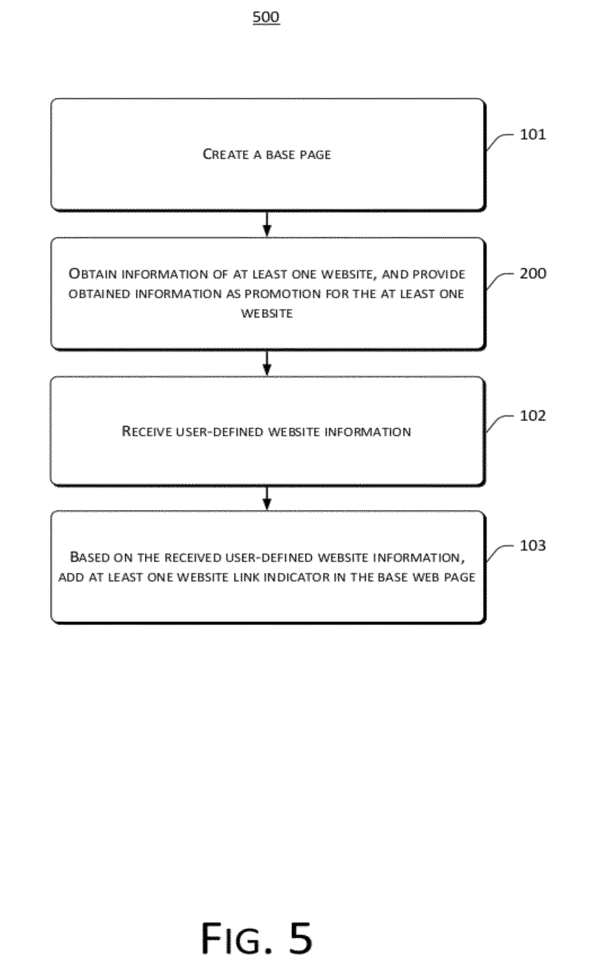

FIG. 5 illustrates a method 500 of a second exemplary embodiment. Compared to method 100 of the first exemplary embodiment showing in FIG. 1, before receiving the customized website information, the method 500 includes an additional step S200.

At S200, basic information of at least one website is obtained. The obtained basic website information is used to promote the at least one website. The basic information of the at least one website at least includes the website name and its address.

It is to be understood that when the Internet navigation page is generated for the first time, it may be necessary to add a large number of web link logos. If each added website link includes customized information from the user, then the operation will be more complicated. With the present exemplary implementation scheme, before receiving user-defined website information, the system can first ask the user to recommend one or more website choices. Three methods for doing so will now be described.

### Method 1

The system can ask the user to recommend websites based on the existing information on the website. For example, the system will make available to the user website information stored on the navigation website. In other words, it will make available to the user basic information of frequently used or popular website. Here, a website's basic information includes the website name and address. Optimally, a line related to the website's introductory text could also be included as part of the website's basic information. From among the recommended websites in the system, the user can choose one or more websites. Based on the user's choice, the system can automatically generate more of the user-defined website information. Furthermore, based on this information, the system can automatically add corresponding web link logos onto the page, avoiding the hassle of the user manually adding them.

### Method 2

For the optimization scheme of this exemplary implementation, based on the user's online history, the system can automatically analyze the user's Internet habits and recommend to the user the corresponding website. The method first obtains information related to the user's online history, analyzes this information, and then obtains at least basic information of the website that the user habitually visits.

The information related to the use's online history may include historical information of the websites and/or historical operational behavior of a browsing tool used by the user. The historical information of the website browsed by the user may include the following information: visited URLs, frequency of visits, visit duration, whether there is account information in the website, whether or not there are download and upload records, etc. The historical operating behavior information of the browsing tool may include the following information: what page the user previously set up as the startup page or home page, the frequency that the address of a certain website is inputted on the address bar, the number of times a certain URL is clicked from Favorites, the recurrence of adding certain websites into Favorites, etc.

The system can data mine the above accessed information. For example, the system may analyze the user's browsing behavior for some period in the past or the operating behavior when using the browser. Furthermore, the system may obtain one or more possible websites that the user may like. The system may then obtain these websites' basic information (including website name and address) and recommend it to the user in a list form. The user can directly select from the recommendation those websites to be added on the navigation page. The system generates user-defined website information based on the user's choice and adds the corresponding website link logo on the page.

### Method 3

For another optimization scheme, the system may ask the user to recommend websites based on the user's search requirement.

As previously described with respect to the first exemplary embodiment, a search engine module may further be added on the navigation page. When the user employs the search engine module to look for a website, the obtained search results include websites which are very likely to interest the user. Based on this analysis, the system in the search engine module can return search results simultaneously, and recommend to the user one or more websites corresponding to the search results.

For example, the system may list the names and addresses of the first five websites obtained from the search results, and recommend it to the user. From the recommended information, the user can choose directly the website to be added on the page. Based on the user's choice, the system further generates user-defined website information and adds the corresponding link logo on the page.

Described above are three ways of asking the user to recommend website information. The user can choose based on the system's recommended website information. Therefore, manual work in adding a website link logo can thus be reduced. By integrating the exemplary embodiment, one can see that the user in the process can also correspondingly customize the link name as well as its location on the page. Of course, a person ordinarily skilled in the art can also choose to use other methods to ask the user recommended website information. The scope of the present disclosure is not limited to the disclosed exemplary embodiments and scenarios.

The steps provided to ask a user to recommend website information in the exemplary implementation can also be triggered by the user's operations. For example, opening a navigation page, closing a navigation page, or clicking a specific function key can automatically trigger running the system at real-time or periodically. In order to avoid repeating the recommendation, after obtaining information about certain website, the system can first compare the obtained website basic information's corresponding URL to the corresponding URL of that website link logo on the current page. If they are the same, they system informs the user that this website has already been added on the page. If the URL is not the same as the one on the current page, the basic information of the website will be the recommended information presented to the user. Thus, it reduces unnecessary actions on the part of the user.

Using the technology of this exemplary implementation, it can be seen that the system can automatically analyze the websites the user may possibly be interested in and recommend it to the user. This allows the user to conveniently customize the navigation page.

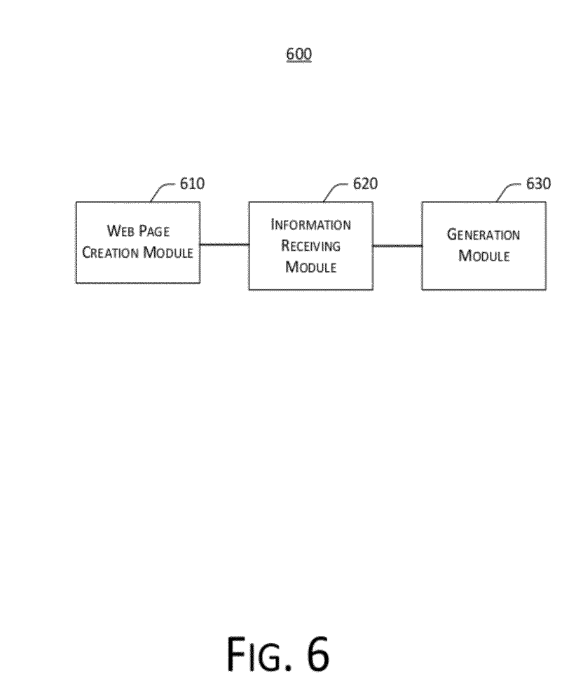

Corresponding to the above method, the present disclosure provides an online navigation page generating system 600 in FIG. 6. The system 600 includes a webpage creation module 610 that sets up the base page, an information receiving module 620 that receives user-defined website information, and a generation module 630 that adds at least one web link logo and generates online navigation page based on the user-defined website information.

The user-defined website information includes: the URL, user-defined website name, as well as the location where a website link logo is added on the base page.

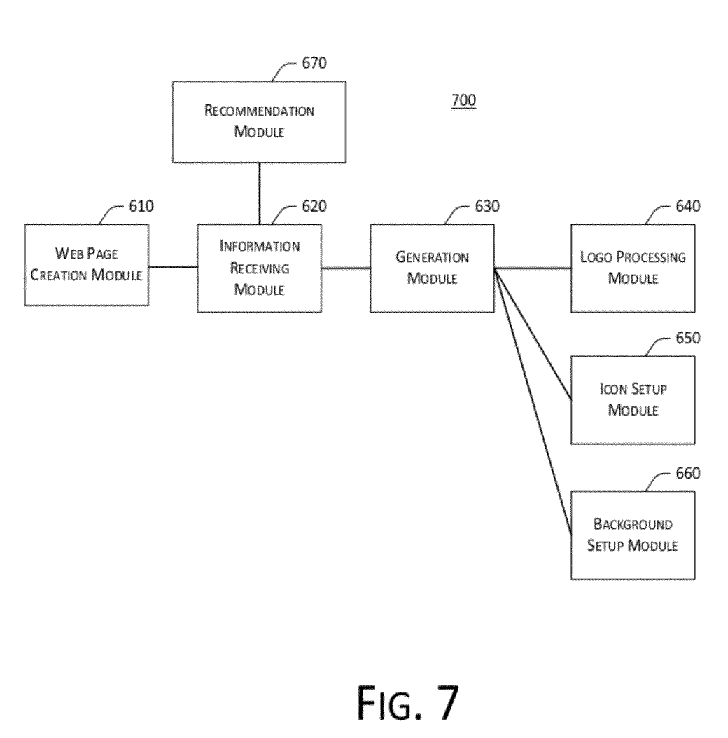

FIG. 7 illustrates another embodiment of an online navigation page generating system 700. In addition to those modules described with reference to FIG. 6, the system 700 includes a logo processing module 640 that edits or deletes website link logo based on the user operation, an icon setup module 650 that sets up icons for website link logo, where an icon can be a default icon or a user-defined icon, a background setup module 660 that sets up a background image for the base page, where the background image can be a default background image or a user-defined background image, and a recommendation module 670 that obtains at least one website's basic information before the information receiving module 620 receives the user-defined website information. The editing by the logo processing module 640 includes editing the web link logo's corresponding URL, user-defined name, and/or the website link logo on the base page.

The website's basic information includes the website name and address.

In one embodiment, the recommendation module 670 may include: a comparison unit, that compares the obtained website's basic information to the corresponding website address, to see whether or not the website link logo on the current base page is the same as the corresponding website address, and a recommendation unit, used when the comparison unit's result is negative. In such case, the website's basic information is turned into the recommended website information that is made available to the user.

For convenience, each system feature is described separately above. Of course, in implementing the present disclosure, each module's feature can be executed by one or more common software and/or hardware.

From the exemplary embodiments described above, a person skilled in the art can clearly understand that the disclosed method may be implemented using software and universal hardware platforms. The technical scheme of the present disclosure can be implemented as software products, which can be stored in the storage medium like ROM/RAM, magnetic disk, or CD. It may comprise a certain number of instructions which will enable a computer (such as a personal computer, server or network equipment) to execute the method described in various exemplary embodiments, or a certain part of the exemplary embodiment, of the present disclosure.

Every exemplary embodiment in the manual is described using a progressive approach. The similar parts of every exemplary embodiment can be seen in one another. Each exemplary embodiment's differences are highlighted. More especially, the exemplary embodiment of the system is basically similar to that of the method, so it is simpler to describe. Where relevant, one can see portions of the exemplary embodiment of the method described. Given that the described exemplary embodiment of the system is merely indicative, the units used to separate components may or may not have physical separations. The unit used to describe the components may or may not be a physical unit. The goal of the exemplary embodiment scheme can be achieved by choosing partial or a whole module based on actual need. A person skilled in the art can promptly comprehend and implement this.

The disclosed method and apparatus may be used in an environment or in a configuration of general or specialized computer system(s). Examples include a personal computer, a server computer, a handheld device or a portable device, a tablet device, a multi-processor system, a system based on a microprocessor, a set-up box, a programmed electronic device, a network PC, a small-scale computer, a large-scale computer, or a distributed computing environment including any system or device above.

The present disclosure may be described within the general context of computer-executable instructions executed by a computer, such as a program module. Generally, a program module includes routines, programs, objects, modules, and data structure, etc., for executing specific tasks or implementing specific abstract data types. The disclosure may also be implemented in a distributed computing environment. In the distributed computing environment, a task is executed by remote processing devices which are connected through a communication network. In a distributed computing environment, the program module may be located in storage media (which include storage devices) of local and remote computers.

Though the present disclosure is described using the exemplary embodiments, it is appreciated that a person of ordinary skills in the art can alter or modify the disclosed embodiments in many different ways without departing from the spirit and the scope of this disclosure.

What is claimed is:

1. A method of generating an Internet navigation page, the method comprising:
creating a base page;
receiving user-defined website information; and
adding at least one website link logo on the base page based on the user-defined website information, the user-defined website information comprising a website address, a customized website name, and a location of the website link logo on the base page.

2. The method of claim 1, further comprising:
modifying or deleting the website link logo added on the base page based on user input, wherein modifying the website link logo comprises modifying at least one of a website address corresponding to the website link logo, the customized web name, or an original location of the website link logo.

3. The method of claim 1, further comprising:
setting up an icon for the website link logo, the icon being either a default icon or a user-defined icon.

4. The method of claim 1, further comprising:
setting up a background image for the base page, the background image being either a default background image or a user-defined background image.

5. The method of claims 1, wherein before receiving the user-defined website information the method further comprises:
obtaining basic information of at least one website, the basic information including a website name and a website address; and
providing to a user the obtained basic information of the at least one website as recommended website information.

6. The method of claim 5, wherein obtaining basic information of at least one website comprises:
obtaining an online history of the user; and
analyzing the online history to obtain information about visiting habits of the user to the at least one website.

7. The method of claim 6, wherein the online history of the user comprises a browsing history of the user, historical behaviors of the user using browsing tools, or a combination thereof.

8. The method of claim 5, wherein the base page contains a search engine module, and wherein obtaining basic information of at least one website comprises:
obtaining search results of the search engine module; and
obtaining basic information of the at least one website from the search results.

9. The method of claim 5, wherein providing to a user the obtained basic information of the at least one website as recommended website information comprises:
determining whether or not the address of the at least one website is the same as the address corresponding to the website link logo of the base page; and
if the address of the at least one website is not the same as the address corresponding to the website link logo of the base page, then providing the website basic information as the recommended website information to the user.

10. A system of generating online navigation page, the system comprising:
a webpage creation module that creates a base page;
an information receiving module that receives user-defined website information; and
a generation module that adds a website link logo on at least one website and generates an Internet navigation page according to the user-defined information, the user-defined website information comprising a website address, a customized website name, and a location of the website link logo on the base page.

11. The system of claim 10, further comprising:
a logo processing module that modifies or deletes the website link logo on the base page according to user input, wherein modifying the website link logo comprises modifying at least one of a website address corresponding to the website link logo, the customized web name, or an original location of the website link logo.

12. The system of claim 10, further comprising:
an icon setup module that sets up an icon for the website link logo, the icon being either a default icon or a user-defined icon.

13. The system of claim 10, further comprising:
a background module that sets up a background image for the base page, the background image being either a default background image or a user-defined background image.

14. The system of claims 10, further comprising:
a recommendation module that obtains basic information of at least one website before the user-defined information is received by the information receiving module, the website basic information is provided to the user as recommended website information, the basic information of the at least one website including a website name and a website address.

15. The system of claim 14, wherein the recommendation module comprises:
a comparing unit that compares the obtained website's basic information to the corresponding website address to determine whether or not the website link logo on the current base page is the same as the corresponding website address; and
a recommendation unit that provides the website's basic information as the recommended website information to the user when the website link logo on the current base page is not the same as the corresponding website address.
